(19) United States
(12) Patent Application Publication
(10) Pub. No.: US 2008/0255019 A1
(43) Pub. Date: Oct. 16, 2008

(54) Flowable Carpet Cleaning Composition Containing Hydrogen Peroxide

(75) Inventors: Alessandro Cagnina, Mira (IT); Zefferino Righetto, Mira (IT)

Correspondence Address: NORRIS, MCLAUGHLIN & MARCUS, 875 THIRD AVE, 18TH FLOOR, NEW YORK, NY, 10022, US

(73) Assignee: RECKITT BENCKISER N.V., Hoofddorp (NL)

(21) Appl. No.: 12/089,427

(22) PCT Filed: Sep. 9, 2006
(86) PCT No.: PCT/GB06/03514

§ 371 Date: Apr. 7, 2008

(30) Foreign Application Priority Data
Oct. 10, 2005 (GB) 0520524.0

(51) Int. Cl. C11D 3/382

(52) U.S. Cl. 510/280

(57) ABSTRACT

A method of cleaning carpet fibres comprises applying to soiled carpet fibres a formulation. The formulation comprises:
a) Wood or plant derivative, in particular cellulose, and wood flour mixtures, at a level of less than 50% w/w
b) hydrogen peroxide, at a level of less than 5.5% w/w;
c) to 15% w/w of a solvent or mixture of solvents; and
d) to 15% w/w of a salt or mixtures of salts.

The invention relates to flowable carpet cleaning compositions containing hydrogen peroxide, a solvent and a salt. The formulation shows efficient stain removal from carpet, including the carpet backing, without damaging the fibre or colours of the carpet. Furthermore, the formulations show also efficient particulate soil removal from the carpet.

Carpet cleaning shampoos leaves the carpet wet for many hours and the cleaned area cannot be walked with inconvenience to the user. Powder carpet cleaners have the advantage of drying more quickly, generally powder carpet cleaners are vacuumed after 20-30 minutes leaving the carpet dry. Beside the benefit of cleaning soil in large area, this kind of powders can be used to remove stains.

The present invention is related to a flowable powder for carpet cleaning that shows good soil and stain removal versus powder carpet cleaning products on the market, good formula stability and no or low carpet damage. The formula of this invention additionally removes stains from deep within the carpet, preventing the wicking effect often found, that is the reappearance of the stains from the backing of the carpet to the surface through the fibres due to humidity. The formulations of the present invention are applied directly to the carpet, then the area is brushed with a suitable brush and the formulation is finally vacuumed with a vacuum cleaner or picked-up with any suitable mean.

Therefore, we present as a first aspect of the invention a method of cleaning carpet fibres comprising applying to soiled carpet fibres a formulation comprising:
a) Wood or plant derivative, in particular cellulose, and wood flour mixtures, at a level of less than 50% w/w
b) hydrogen peroxide, at a level of less than 5.5% w/w;
c) 0.1 to 15% w/w of a solvent or mixture of solvents; and
d) 0.1 to 15% w/w of a salt or mixtures of salts.

Preferably the formulation is left on the carpet for less than an hour, more preferably for less than 45 minutes and even more preferably for less than 30 minutes in case of normal soil removal.

It is proposed that the wood or plant derivative is the carrier for the active liquid formula and an absorbing material. It is assumed that it works as an impregnated micro sponge which release the liquid solution when rubbed with a brush or any other mean against the carpet fibres and then re-absorb the particulate soil and/or the staining material.

Preferred types of wood derivative include chemical thermal mechanical pulp (CTMP) and cellulose. Preferred types of plant derivative include cellulose. Cellulose derived from wood materials are preferred. A particularly preferred cellulose type is beech wood cellulose.

Exemplary chemical thermal mechanical pulp are Arbocel FT 00 and Arbocel TF HG (supplied by J. Rettenmaier & Sohne). Among the cellulose derived from wood Arbocel B 800, Arbocel B 800 X, Arbocel G 350, Arbocel R 200, Vitacel L 00 (all supplied by J. Rettenmaier & Sohne) and similar. Among the cellulose derived from plant Vitacel WF series (from wheat) and Vitacel HF series (from oat) supplied by J. Rettenmaier & Sohne.

Preferred wood flours are Lignocel C120 (from soft wood) and Lignocel BB 120 (from hard wood).

Hydrogen peroxide is found to be effective at levels of from 0.1-5.5% w/w, preferably between 0.5 and 3% w/w. Hydrogen peroxide is commercially available in different grades, at 8%, 35% and 50% w/w active and it is generally stabilised by the use of chelating agents.

Preferably the solvent is found at levels of 0.01 to 15% w/w, more preferably 1 to 10% w/w, more preferably 2 to 9% w/w, more preferably 2.5 to 8% w/w, more preferably 2.5 to 7% w/w, more preferably 2.5 to 5% w/w, and most preferably about 3% w/w. The solvent constituent may include one or more alcohol, glycol, acetate, ether acetate or glycol ether. Exemplary alcohols useful in the compositions of the invention include C₂-C₈ primary and secondary alcohols which may be straight chained or branched, preferably pentanol and hexanol. More preferably the solvent is a glycol ether. Preferred examples of glycol ethers include glycol ethers having the general structure Ra—O—Rb—OH, wherein Ra is an alkoxy of 1 to 20 carbon atoms, or aryloxy of at least 6 carbon atoms, and Rb is an ether condensate of propylene glycol and/or ethylene glycol having from 1 to 10 glycol monomer units. Preferred are glycol ethers having 1 to 5 glycol monomer units.

Specific and preferred solvents are selected from propylene glycol methyl ether, dipropylene glycol methyl ether, dipropylene glycol propyl ether, dipropylene glycol butyl ether, tripropylene glycol methyl ether, propylene glycol n-propyl ether, ethylene glycol n-butyl ether, diethylene glycol n-butyl ether, diethylene glycol methyl ether, propylene glycol, ethylene glycol, isopropanol, ethanol, methanol, diethylene glycol monoethyl ether acetate, and particularly useful are, propylene glycol phenyl ether, ethylene glycol hexyl ether and diethylene glycol hexyl ether.

Most preferably the solvent or mixture of solvent is from the propanol series (Dowanol P-series) and among these Dipropylene Glycol n-Propyl Ether, Dipropylene Glycol n-Butyl Ether and Propylene Glycol Phenyl Ether. These are commercially available from Dow Chemicals as Dowanol DPnP, Dowanol DPnB and Dowanol PPH respectively.

It has been found that the addition of a salt, in combination with the solvents, improves the stain removal performance. It is thought it is due to a micro-scrubbing action exercised by the small granules of salt. Preferably the salt aid is found at levels of 0.01 to 15% w/w, more preferably 1 to 14% w/w, more preferably 2 to 13% w/w, more preferably 3 to 12% w/w, more preferably 5 to 10% w/w, more preferably 7 to 10% w/w, and most preferably about 9% w/w. The salt may include a metal or an ammonium salt. Suitable salts for use in the invention include divalent salts such as MgSO₄, MgCl₂, CaCl₂, Ca(CH₃COO)₂, SrCl₂, BaCl₂, ZnCl₂, ZnSO₄, FeSO₄, and CuSO₄; monovalent salts such as LiCl, NaCl, NaBr, NaI, KCl, CsCl, Li₂SO₄, and Na₂SO₄; polyvalent salts such as AlCl₃ and aluminium citrate; and ammonium salts such as NH₄Cl, (NH₄)₂SO₄ and (CH₃)₄NCl.

Most preferably the salt aid is Na₂SO₄ or NaCl.

Preferably a surfactant is found at levels of 0.1 to 10% w/w. Preferably the surfactant is a nonionic, amphoteric or an anionic surfactant, most preferably an anionic surfactant. Such anionic surface active agents are frequently provided in a salt form, such as alkali metal salts, ammonium salts, amine salts, aminoalcohol salts or magnesium salts. Preferably the anionic surfactant is selected from or more sulfate or sulfonate compounds including: alkyl sulfates, alkyl ether sulfates, alkylamidoether sulfates, alkylaryl polyether sulfates, monoglyceride sulfates, alkylsulfonates, alkylamide sulfonates, alkylarylsulfonates, olefinsulfonates, paraffin sulfonates, alkyl sulfosuccinates, alkyl ether sulfosuccinates, alkylamide sulfosuccinates, alkyl sulfosuccinamate, alkyl sulfoacetates, alkyl phosphates, alkyl ether phosphates, acyl sarconsinates, acyl isethionates, and N-acyl taurates. Generally, the alkyl or acyl radical in these various compounds comprise a carbon chain containing 12 to 20 carbon atoms.

Particularly preferred are alkyl sarcosinate, sulfosuccinate and alkyl sulfate anionic surfactants having a straight chain or branched alkyl chain having from about 8 to about 18 carbon atoms, saturated or unsaturated, and the longest linear portion of the alkyl chain is 15 carbon atoms or less on the average, and a cation which makes the compound water soluble especially an alkali metal such as sodium or magnesium, ammonium or substituted ammonium cation, and x is from 0 to about 4. Most preferred are the non-ethoxylated C₁₂₋₁₅ primary and secondary alkyl sulfates, especially sodium lauryl sulfate.

Most desirably, the anionic surfactant is selected to be of a type which dries to a friable powder. This facilitates their removal from carpets and carpet fibers, such as by brushing or vacuuming.

The chelating agent is added at a level between 0.01 to 4% w/w, preferably between 0.1-1% w/w. Examples of chelating agents are described below:
the parent acids of the monomeric or oligomeric polycarboxylate chelating agents or mixtures therefore with their salts, e.g. citric acid or citrate/citric acid mixtures are also contemplated as useful builder components.
borate builders, as well as builders containing borate-forming materials than can produce borate under detergent storage or wash conditions can also be.
iminosuccinic acid metal salts
polyaspartic acid metal salts.
examples of bicarbonate and carbonate builders are the alkaline earth and the alkali metal carbonates, including sodium carbonate and sesqui-carbonate and mixtures thereof. Other examples of carbonate type builders are the metal carboxy glycine and metal glycine carbonate.
ethylene diamino tetra acetic acid and salt forms.
water-soluble phosphonate and phosphate builders are useful for this invention. Examples of phosphate builders are the alkali metal tripolyphosphates, sodium potassium and ammonium pyrophosphate, sodium and potassium and ammonium pyrophosphate, sodium and potassium orthophosphate sodium polymeta/phosphate in which the degree of polymerisation ranges from 6 to 21, and salts of phytic acid. Specific examples of water-soluble phosphate builders are the alkali metal tripolyphosphates, sodium potassium and ammonium pyrophosphate, sodium and potassium and ammonium pyrophosphate, sodium and potassium orthophosphate, sodium polymeta/phosphate in which the degree of polymerization ranges from 6 to 21, and salts of phytic acid. The polymers are used in this invention at a level between 0.01-25% w/w, preferably between 0.1-5% w/w are water-soluble compounds. Such polymers include the polycarboxylates containing two carboxy groups include the water-soluble salts of succinic acid, malonic acid, (ethylenedioxy) diacetic acid, maleic acid, diglycolic acid, tartaric acid, tartronic acid and fumaric acid, as well as the ether carboxylates and the sulfinyl carboxylates.

Polycarboxylates containing three carboxy groups include, in particular, water-soluble citrates, aconitrates and citraconates as well as succinate derivates such as the carboxymethloxysuccinates described in GB-A-1,379,241, lactoxysuccinates described in GB-A-1,389,732, and aminosuccinates described in NL-A-7205873, and the oxypolycarboxylate materials such as 2-oxa-1,1,3-propane tricarboxylates described in GB-A-1,387,447.

Polycarboxylate containing four carboxy groups include oxydisuccinates disclosed in GB-A-1,261,829, 1,1,2,2-ethane tetracarboxylates, 1,1,3,3-propane tetracarboxylates and 1,1,2,3-propane tetracarobyxlates. Polycarboxylates containing sulfo substituents include the sulfosuccinate derivatives disclosed in GB-A-1,398,421, GB-A-1,398,422 and U.S. Pat. No. 3,936,448, and the sulfonated pyrolsed citrates described in GB-A-1,439,000.

Alicylic and heterocyclic polycarboxylates include cyclopentane-cis,cis,cis-tetracarboxylates, cyclopentadienide pentacarboxylates, 2,3,4,5,6-hexane-hexacarboxylates and carboxymethyl derivates of polyhydric alcohols such as sorbitol, mannitol and xylitol. Aromatic polycarboxylates include mellitic acid, pyromellitic acid and the phthalic acid derivatives disclosed in GB-A-1,425,343.

Of the above, the preferred polycarboxylates are hydroxycarboxylates containing up to three carboxy groups per molecule, more particularly citrates.

Additional ingredient is a pH corrector to lower the pH to an acidic one. Among the acids that can be used there are sulphuric acid and citric acid.

pH is between 2 and 7, most preferably between 3 and 6 and even more preferably between 4 and 5.5. Due to the nature of the materials employed in this formulation an improved stability is obtained by having the pH of the whole formula below 6, better if below 5.

Additional, optional, ingredients, such as fragrance and dye, are present at levels of up to 1% w/w, preferably less then 0.5% w/w.

Also in accordance with a second aspect of the present invention there is provided a carpet cleaning product comprising:
a) Wood or plant derivative, in particular cellulose, and wood flour mixtures, at a level of less than 50% w/w
b) hydrogen peroxide, at a level of less than 5.5% w/w;
c) to 15% w/w of a solvent or mixture of solvents; and
d) to 15% w/w of a salt or mixtures of salts aid.

It will be appreciated that features of the first aspect of the invention shall be taken to apply to the second aspect of the invention.

### EXAMPLES

### Example 1

### Soil Removal

Soil removal performance was conducted by soiling a carpet swatch (64×30 cm) with AATCC standard soil following the ASTM D6540 soiling procedure. The carpet was then divided in 6 parts and each part treated with 2.5 gr of the following formulae. Product was applied evenly, brushed with a suitable brush and then vacuumed after 20 minutes. The soil removal % was evaluated after taking instrumental reading (Minolta Chromameter)

Compositions:

| | Example | | |
|---|---|---|---|
| | 1 | 2 | 3 |
| | % | % | % |
| Cellulose¹ | 45 | 42.5 | 40 |
| Sodium Sulphate | 5.00 | 7.50 | 10.00 |
| Na Lauryl Sulfate, 30% | 1.98 | 1.98 | 1.98 |
| IDS Na salt | 0.90 | 0.90 | 0.90 |
| Hydrogen Peroxide, 50% | 1.50 | 1.50 | 1.50 |
| Copolymer² | 0.90 | 0.90 | 0.90 |
| Dowanol PPH³ | 0.25 | 0.25 | 0.25 |
| Fragrance | 0.15 | 0.15 | 0.15 |
| Citric Acid | 0.06 | 0.06 | 0.06 |
| Deionised Water | 44.27 | 44.27 | 44.27 |
| Total | 100.00 | 100.00 | 100.00 |
| pH | 6.2 | 6.3 | 6.2 |

¹Arbocel B800 - J. Rettenmaier & Sohne
²Syntran 4022 - Interpolymer
³Propylene Glycol Phenyl Ether

The Examples 1-3 were compared against a reference (Sapur, Henkel, Germany).

Results:

| | Soil Removal, % |
|---|---|
| Sapur | 38.7 |
| Ex. 1 | 41.5 |
| Ex. 2 | 45.8 |
| Ex. 3 | 49.9 |

The higher content of Na₂SO₄ leads to better soil removal performance.

### Example 2

### Stain Removal

This method has been designed for the evaluation of stain removal performance of carpet cleaner formulations and especially of trigger products. The Tuba™ carpet cleaner powder has been used as a reference.

Dirty motor oil was used as references of greasy stains; red wine, coffee was considered an examples of an oxidisable stain. Tomato was considered as an example of a mixed stain (greasy, oxidasible and particulate.

The stains were applied to nylon carpets following the procedures below:

| | |
|---|---|
| Dirty Motor Oil | 0.1 grams sprayed with an airbrush using a |
| | 5 cm diameter template. Allow any |
| | sediment to settle and decant oil into a clean |
| | container. |
| Tomato | Pls. let me know how the tomato stain was generated. |
| Red Wine | 1.5 gram sprayed with an airbrush using a |
| | 5 cm diameter template - Tavernello |
| Coffee | 1 gram sprayed with an airbrush using a |
| | 5 cm diameter template - milk (3 ml) & sugar (20 g) |

The stains were allowed to set for 24 hours before cleaning. The cleaning process was carried out by pouring 5 grams of the product onto the stain, working the product with a brush and leaving it to dry and then vacuumed. The area is then left to dry for 24 hours.

The cleaning performance is evaluated by measuring the carpet with a portable spectrophotometer before staining, after staining and after the cleaning process. The results are reported as a stain removal percentage.

Compositions:

| | Example | | | | | |
|---|---|---|---|---|---|---|
| | 1 | 4 | 5 | 6 | 7 | |
| | % | % | % | % | % | 7a |
| Cellulose¹ | 45.00 | 45.00 | 45.00 | 45.00 | 45.00 | 42.8 |
| Sodium | 5.00 | 5.00 | 5.00 | 5.00 | 5.00 | 8.00 |
| Sulphate | | | | | | |
| Na Lauryl | 1.98 | 1.98 | 1.98 | 1.98 | 1.98 | 2.00 |
| Sulfate, 30% | | | | | | |
| IDS Na | 0.90 | 0.90 | 0.90 | 0.90 | 0.90 | 0.90 |
| salt, 34% | | | | | | |
| Hydrogen | 1.50 | 1.50 | 1.50 | 1.50 | 1.50 | 3.00 |
| Peroxide, 50% | | | | | | |
| Copolymer² | 0.90 | 0.90 | 0.90 | 0.90 | 0.90 | — |
| Dowanol PPH³ | 0.25 | 0.25 | 0.25 | 0.25 | 0.25 | 0.35 |
| Fragrance | 0.15 | 0.15 | 0.15 | 0.15 | 0.15 | 0.20 |
| Citric Acid | 0.06 | 0.06 | 0.06 | 0.06 | 0.06 | — |
| Deionised | to 100 | to 100 | to 100 | to 100 | to 100 | to 100 |
| Water | | | | | | |
| Dowanol | | 5.00 | 10.00 | | | 1.00 |
| DPnP⁴ | | | | | | |
| Dowanol | | | | 4.00 | 8.00 | — |
| DPnB⁵ | | | | | | |
| Total | 100.00 | 100.00 | 100.00 | 100.00 | 100.00 | 100.00 |
| pH | 6.2 | 6.3 | 6.2 | 6.2 | 6.1 | 4.5 |

¹Arbocel B800 - J. Rettenmaier & Sohne
²Syntran 4022 - Interpolymer
³Propylene Glycol Phenyl Ether
⁴Dipropylene Glycol n-Propyl Ether
⁵Dipropylene Glycol n-Butyl Ether

Results:

| | TOMATO | DMO | RED WINE | COFFEE |
|---|---|---|---|---|
| TUBA | 39.0 | 30.8 | 55.2 | 45.5 |
| Ex. 1 | 46.5 | 33.3 | 62.6 | 50.4 |
| Ex. 4 | 46.2 | 42.6 | 74.2 | 67.7 |
| Ex. 5 | 49.3 | 42.1 | 77.7 | 64.8 |
| Ex. 6 | 50.5 | 45.5 | 68.1 | 64.4 |
| Ex. 7 | 53.3 | 47.5 | 74.2 | 58.4 |

The use of solvents like glycol ethers (Dowanol PPH and Dowanol DPnP or DPnB) greatly improves the performance on stain removal.

### Example 3

### Stain Removal

The following is a comparison at different levels of sodium sulphate. Same procedure as for the previous example was used.

Compositions:

Example

| | 8 | 9 |
|---|---|---|
| | % | % |
| Cellulose¹ | 44.00 | 44.00 |
| Sodium Sulphate | 6.00 | 9.00 |
| Na Lauryl Sulfate, 30% | 1.975 | 1.975 |
| IDS Na salt | 0.900 | 0.900 |
| Hydrogen Peroxide, 50% | 1.500 | 1.500 |
| Dowanol PPH² | 0.350 | 0.350 |
| Fragrance | 0.180 | 0.180 |
| Citric acid | 0.060 | 0.060 |
| Dowanol DPnP³ | 3.00 | 3.00 |
| Deionised Water | to 100 | to 100 |
| Total | 100.00 | 100.00 |
| PH | 6.3 | 6.2 |

¹Arbocel B800 - J. Rettenmaier & Sohne
²Propylene Glycol Phenyl Ether
³Dipropylene Glycol n-Propyl Ether

Results:

| | | | RED | |
|---|---|---|---|---|
| | TOMATO | DMO | WINE | COFFEE |
| Ex. 8 | 55.3 | 33.2 | 70.3 | 45.8 |
| Ex. 9 | 54.3 | 32.6 | 73.9 | 59.4 |

Increased performance on Coffee and Red Wine.

### Example 4

### Stain Removal

The below formula was compared with 3 product actually in the market: Tuba (Erdal Rex, Germany), Sapur (Henkel, Germany) and Resolve High Traffic Granules (Reckitt Benckiser, USA).

Procedure as described above, quantity applied is 2.5 grams per stain.

Compositions:

| | Example |
|---|---|
| | 10 |
| | % |
| Cellulose¹ | 43.5 |
| Wood flour² | 0.5 |
| Sodium Sulphate | 9.00 |
| Na Lauryl Sulfate, 30% | 1.975 |
| IDS Na salt | 0.900 |
| Hydrogen Peroxide, 50% | 1.500 |
| Dowanol PPH³ | 0.350 |
| Fragrance | 0.2 |
| Sulphuric acid | to pH |
| Dowanol DPnP⁴ | 3.00 |
| Deionised Water | to 100 |
| Total | 100.00 |
| pH | 4.5 |

¹Arbocel B 800 - J. Rettenmaier & Sohne
²Lignocel C 120 - J. Rettenmaier & Sohne
³Propylene Glycol Phenyl Ether
⁴Dipropylene Glycol n-Propyl Ether

Results:

| | | | RED | |
|---|---|---|---|---|
| | TOMATO | DMO | WINE | COFFEE |
| Ex. 10 | 47.79 | 29.21 | 69.67 | 72.34 |
| Tuba | 43.06 | 18.11 | 50.58 | 51.34 |
| Sapur | 33.18 | 7.06 | 51.61 | 44.15 |
| Resolve | 39.05 | 30.81 | 41.30 | 51.04 |
| high traffic | | | | |

Ex. 10 composition is superior to all the 3 carpet cleaning powders currently available on the market.

Storage Stability Test:

### Results for Storage Stability Test:

In the table below are reported the storage rating values (SR) per each storage condition and the hydrogen peroxide loss percentage versus starting value. SR values of 3 or below are considered as good storage stability.

6 Weeks
H₂O₂
Loss %

| Product | 25° C. | 40° C. |
|---|---|---|
| Ex 1 | 0.4 | 12.8 |
| Ex 8 | 0.0 | 7.2 |
| Tuba | 11.8 | 51.4 |
| Sapur | 2.9 | 15.0 |

The Examples in accordance with the invention display excellent H₂O₂ stability. This is particularly surprising given that cellulose and wood derivatives typically contain heavy metals (such as Fe, Co, Mn, Cu, Ni, Al, etc.) which normally catalyse H₂O₂ decomposition.

1. A method of cleaning carpet fibres comprising applying to soiled carpet fibres a formulation comprising:
a) wood, and/or plant derivative, and/or wood flour mixtures, present at a level of less than 50% w/w
b) hydrogen peroxide, present at a level of less than 5.5% w/w;
c) a solvent or mixture of solvents present at a level of less than 15% w/w; and
d) a salt or mixture of salts present at a level of less than 15% w/w.

2. A method according to claim 1, wherein the solvent or mixture of solvents is present in an amount from 0.01-15% w/w.

3. A method according to claim 1 wherein the solvent or mixture of solvents is selected from: propylene glycol phenyl ether and/or dipropylene glycol propyl ether and/or dipropylene glycol butyl ether.

4. A method according to claim 1 wherein the salt or mixture of salts is present in an amount of from 0.01-15% w/w.

5. A method according to claim 1, wherein the salt is Na₂SO₄ or NaCl.

6. A method according to claim 1, wherein the composition contains cellulose.

7. A method according to claim 1, wherein the pH is between 2 and 7.

8. A method according to claim 1, wherein the backing to the carpet is cleaned in addition to the carpet fibres.

9. A method according to claim 1, wherein the formulation is applied via a pouring device on the container.

10. A method according to claim 1, wherein the powder is removed from the carpet within an hour after application.

11. A carpet cleaning product composition comprising:
a) wood, and/or plant derivative, and/or wood flour mixtures, at a level of less than 50% w/w
b) hydrogen peroxide present at a level of less than 5.5% w/w;
c) a solvent or mixture of solvents present in an amount of to 15% w/w; and
d) a salt or mixture of salts present in an amount of to 15% w/w.

12. A method according to claim 7, wherein the pH is between 3 and 6.

13. A method according to claim 12, wherein the pH is between 4 and 5.5.

14. A method according to claim 18 wherein the powder is removed from the carpet within 45 minutes after application.

15. A method according to claim 14 wherein the powder is removed from the carpet within 30 minutes after application.

16. A carpet cleaning product composition according to claim 11 wherein the solvent or mixture of solvents is selected from: propylene glycol phenyl ether and/or dipropylene glycol propyl ether and/or dipropylene glycol butyl ether.

17. A carpet cleaning product according to claim 11 which comprise from 0.01-15% w/w of a salt or mixture of salts.

18. A method according to claim 11, wherein the salt is Na₂SO₄ or NaCl.

19. A method according to claim 1 wherein the composition contains a cellulose component.
